(19) United States
(12) Patent Application Publication
(10) Pub. No.: US 2010/0269443 A1
(43) Pub. Date: Oct. 28, 2010

(54) Tongue-in-groove floor and wall panels using multiple bonded sheet construction

(76) Inventor: Ziming Shen, Staten Island, NY (US)

Correspondence Address: Alfred Walker, 225 Old Country Road, Melville, NY, 11747, US

(21) Appl. No.: 12/386,825

(22) Filed: Apr. 23, 2009

(51) Int. Cl. E04C 2/40; E04B 2/72; E04B 1/61; E04B 9/04; E04F 13/076; E04F 15/022; E04F 15/04; E04F 13/10; B32B 3/00

(52) U.S. Cl. 52/506.09; 52/592.1; 52/586.1; 52/506.01; 428/172

(57) ABSTRACT

Interlocking tongue and groove floor and wall panels use multiple bonded sheet construction, preferably three sheets, of material, such as plywood, bonded together Other rigid durable sheet materials may be used. The shape is preferably either square or rectangular. By offsetting the middle sheet layer so that two adjacent sides extend beyond the top and bottom layers which are in registration, a tongue is developed on two adjacent sides while the opposite sides will have grooves. Thus such panels can be used to cover a large floor or wall area using normal tongue-in-groove techniques by fitting the protruding tongues into the grooves of adjacent panels In an alternate embodiment, the middle sheet is smaller in size than the top and bottom sheets which are in registration. The middle sheet is centered within the top and bottom sheets thus forming grooves on all four edges.

### FIELD OF THE INVENTION

The present invention relates to tongue and groove floor, ceiling and wall panels using multiple bonded sheet construction.

### BACKGROUND OF THE INVENTION

Floor panels, such as parquet floor panels, are typically made of an array of interlocking tongue and groove panels. However, often the grooves are gouged out of a single piece of wood, and the corresponding tongues are sculpted out of a single piece of wood, making their manufacture time consuming and subject to minute, small errors.

### OBJECTS OF THE INVENTION

It is therefore an object of the present invention to provide tongue and groove floor, ceiling and wall panels using multiple bonded sheet construction, with minimal or no gouging or sculpting of pieces of wood.

It is also an object to provide a panel made up of three sheets of substantially the same equal thickness, and to form respective protruding tongues and receptacle grooves from overlapping of the substantially equal thick sheets forming the panel.

It is also an object of the present invention to provide a relatively tight fit of the tongue portions into the respective groove portions of the assembled sheets forming each panel.

It is also an object of the present invention to be able to install multiple floor, ceiling or wall board panels in a single plane parallel to the surface upon which the panels are being installed.

Other objects which become apparent from the following description of the present invention.

### SUMMARY OF THE INVENTION

In keeping with these objects and others which may become apparent, the floor, ceiling and wall panels of this invention are constructed of multiple board sheets, preferably three board sheets, of material bonded together using adhesive. The preferred material for each of the board sheets is plywood which may be of different or the same thickness for each. Other rigid durable sheet materials may be used such as flake board or composites incorporating wood materials. Materials such as foamed PVC can also be used for one or all three of the layers. The three pieces of plywood can be attached not only by adhesive, such as glue, but also by fasteners, such as nails, staples, etc. joining one or more of the three layers. The three pieces of plywood also can have plastic sheets inserted between the panels to reduce moisture between them. Also, the three layers can use different types of plywood. Optionally, each plywood board sheet layer can be treated differently to be water resistant, fire proof or insect resistant, etc. A typical fire resistant wood sealer such as described in U.S. Pat. No. 5,879,593 is mixed with the glue before the glue is applied between the layers. Optionally, waterproof glues, such as Gorilla® glue or Titebond® waterproof glue may be used. Fireproof glue, such as GB 18583-2001/BS5852 manufactured by Stenzhen Gokangali Chemical Laboratory, Ltd. may be used and mixed with the glue. Insect resistant adhesives, such as manufactured by Henkel Adhesives can also be mixed with the glue and applied between the board layers.

In one embodiment for floor boards, all three board sheets are of identical size and shape (although the thickness may be different as desired). The shape, as described in the drawings, is either square or rectangular. (Other tiling shapes, such as hexagons or octagons, with straight sides may also be used.) By offsetting the middle board sheet layer so that two adjacent sides extend beyond the top and bottom board sheet layers which are in registration, a protruding tongue is developed on two adjacent sides while the opposite sides will have grooves. Thus such panels can be used to cover a large floor, ceiling or wall area using normal tongue-in-groove techniques by fitting the protruding tongues into the grooves of adjacent panels; a small amount of adhesive may be used in these fitted edges, but it is not essential in all applications. No routing of the edges is required to form the tongues or grooves.

In an alternate embodiment for walls and ceilings, the middle board sheet is smaller in size than the top and bottom board sheets which are in registration. The middle board sheet is centered within the top and bottom board sheets thus forming grooves on all four edges. To assemble these panels to cover a larger area, separate connecting slat tongues are used to connect the panels thereby acting as the tongues for a tongue-in-groove fit. By using a combination of short slat tongues and long slat tongues, large interconnected areas can be covered. By using slat tongues wider than the depth of two adjacent panel grooves, visible linear grooves the depth of the thickness of the top board sheet are formed between panels. They can be used to simulate a grout line in ceramic tile installations.

The top surface of each panel can be finished in a variety of ways including grooving to simulate a parquet floor or patterns formed of veneers with oriented grain directions. It is also known that the pattern can be enhanced by one or more veneer pieces applied to the top of the assembled panels. Any appropriate sealant and/or stain can be used. Obviously the finish for a floor application would probably be different from that of a wall panel due to wear characteristics. Large inlay designs can be accommodated on several adjacent panels which are then assembled like a jigsaw puzzle to form a coherent design.

The tongue and the reciprocating groove are formed by attaching three panel board sheets, preferably plywood, together in a “sandwiched” overlying pattern. Because the plywood board sheets are flat, the tongues and corresponding grooves extend uni-directionally therefrom. They can be assembled by moving the tongue portions in one surface plane, such as horizontally for a floor or ceiling, and vertically for a wall. They do not need to be inserted at an angle and then locked in place by being moved in a non-planar fashion.

It is further noted that in the case the underlying wall to which the panels are being installed is warped and non-planar, an underlying layer of Sheetrock® wall board can be installed between the panels and underlying warped surface, to provide a relatively flat surface for installation of the array of panels.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a perspective exploded view of three board sheets forming a square panel with integral tongues on two edges and grooves on the other two.

FIG. 2 is a top view of the assembled panel of FIG. 1.

FIG. 3 is a top view of an alternate embodiment square panel with grooves on all four edges.

FIGS. 4A to 4F show a typical installation of the floor board panels, wherein:

FIG. 4A is a top plan view of a floor panel;

FIG. 4B is a front elevation view thereof;

FIG. 4BB is a close up partial detail view of the floor panel in FIG. 4B, taken along view circle line “4BB” of FIG. 4B;

FIG. 4C is a right side elevation view thereof;

FIG. 4D is a close detail view taken along view circle line 5D of FIG. 5C;

FIG. 4E is a top plan view during installation of an array of multiple panels; and

FIG. 4F is a top plan view after completion of installation of the array of multiple panels.

FIGS. 5A to 5R show the installation of a typical wall board, wherein:

FIG. 5A is a top plan view of a wall panel 10 of square configuration as in FIG. 3;

FIG. 5B is a front elevation view thereof;

FIG. 5C is a right side elevation view thereof;

FIG. 5D is a close up detail view taken along view circle line “5D” of FIG. 5C;

FIG. 5E is top plan view of a connecting slat for the panel of FIG. 5A;

FIG. 5F is front view thereof.

FIG. 5G is side view thereof;

FIG. 5GG is a close-up detail view of the connecting slat shown in FIG. 5G, taken along view circle line “GG” of FIG. 5G;

FIG. 5H is a top plan view of a rectangular wall panel;

FIG. 5I is a right side elevation view thereof;

FIG. 5J is a front elevation view thereof;

FIG. 5K is top plan view of a connecting slat for the panel of FIG. 5H;

FIG. 5L is front view thereof;

FIG. 5M is a top plan view of an array of wall panels during installation;

FIG. 5N is a top plan view of the array of wall panels also showing connecting slats;

FIG. 5O is a top plan view of a completed array of wall panels;

FIG. 5P is a top plan view of the array of connecting slat tongues for the wall panels;

FIG. 5Q is inverted cross sectional view viewed through view line “5Q-5Q” of FIG. 5O;

FIG. 5R is a close-up detail view of taken along viewing circle line “5R” of FIG. 5Q.

FIGS. 6A-6R show the installation of a typical ceiling pattern, wherein:

FIG. 6A is a top plan view of a ceiling panel 100 of square configuration, similar to wall panel 10 as in FIG. 3;

FIG. 6B is a front elevation view thereof;

FIG. 6C is a right side elevation view thereof;

FIG. 6D is a close up detail view taken along view circle line “6D” of FIG. 6C;

FIG. 6E is top plan view of a short connecting slat for the panel of FIG. 6A;

FIG. 6F is front view thereof.

FIG. 6G is side view thereof;

FIG. 6H is a close up partial detail thereof, taken along view line circle “6H” of FIG. 6G;

FIG. 6I is a top plan view of a long rectangular slat for the ceiling panel;

FIG. 6J is a front view thereof;

FIG. 6K is a right side elevation view thereof;

FIG. 6L is a close up detail thereof, taken along view line circle “6L” of FIG. 6K;

FIG. 6M is a top plan view of an array of ceiling panels and connecting slats during installation;

FIG. 6N is a top plan view of the array of ceiling panels further during installation;

FIG. 6O is a top plan view of the array of connecting slat tongues for the ceiling panels;

FIG. 6P is a top plan view of a section of panels installed on a ceiling;

FIG. 6Q is an inverted cross sectional view viewed through view line “6Q-6Q” of 6P;

FIG. 6R is a close-up detail view taken along view circle line “6R” of FIG. 6Q.

### DETAILED DESCRIPTION OF THE INVENTION

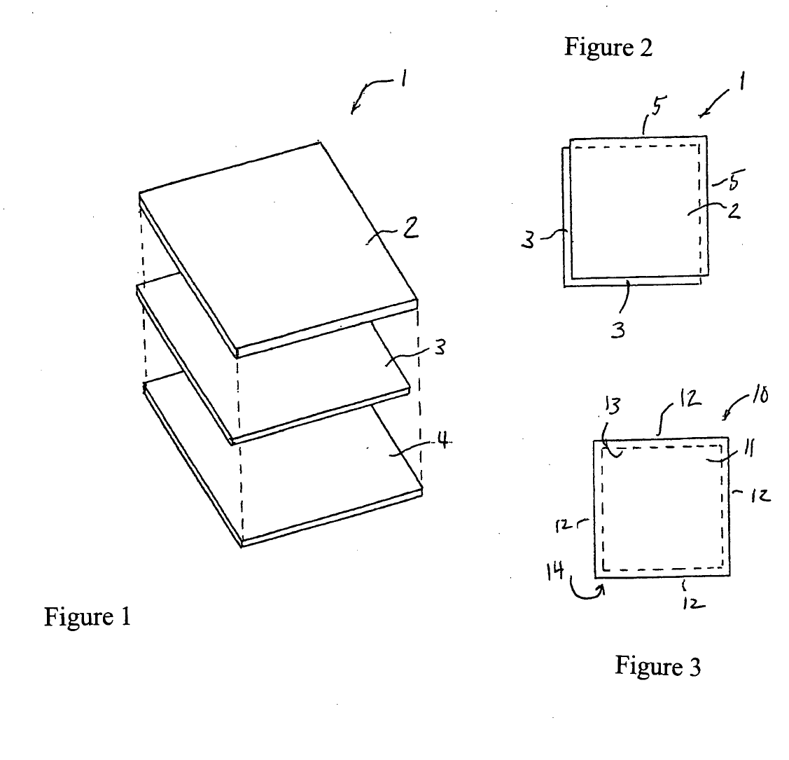

FIG. 1 shows three equal-sized board sheet layers, top 2, middle 3, and bottom 4 which will be adhesively bonded at the factory to form square panel 1 of the first embodiment with an offset middle layer. Each of the layers is preferably a board sheet of plywood. They can all be the same thickness, such as 6 mm, or the board sheets can be of different thickness as desired. These panels, of convenient size such as 12″ or 16″ can be used as floor tiles or for wall covering. While dimensions may vary, preferably square panels 1 have upper board sheets 2 and lower board sheets 4 which are 32 cm in length, sandwiching a mid board sheet 3 of 32 cm in length, which extends outward displaying a protruding tongue of 1.3 cm and a corresponding recess on an opposite side of 1.3 cm in depth. Each board sheet is preferably 6 mm, making panel 1 of three board sheets 2, 3 and 4 about 18 mm in thickness.

Each board sheet is preferably a rectangular cuboid, also called a rectangular parallelepiped, of which all faces are rectangular and where “rectangular” implies both rectangles and squares.

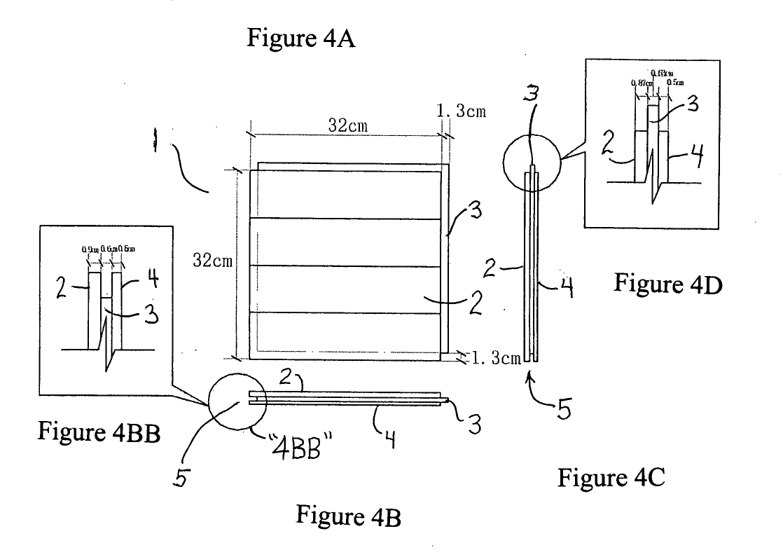

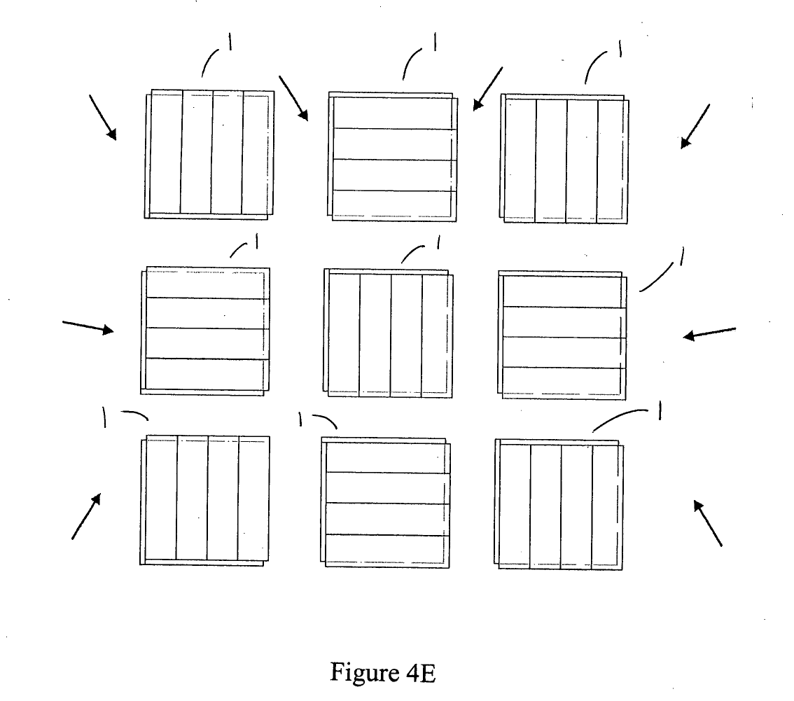

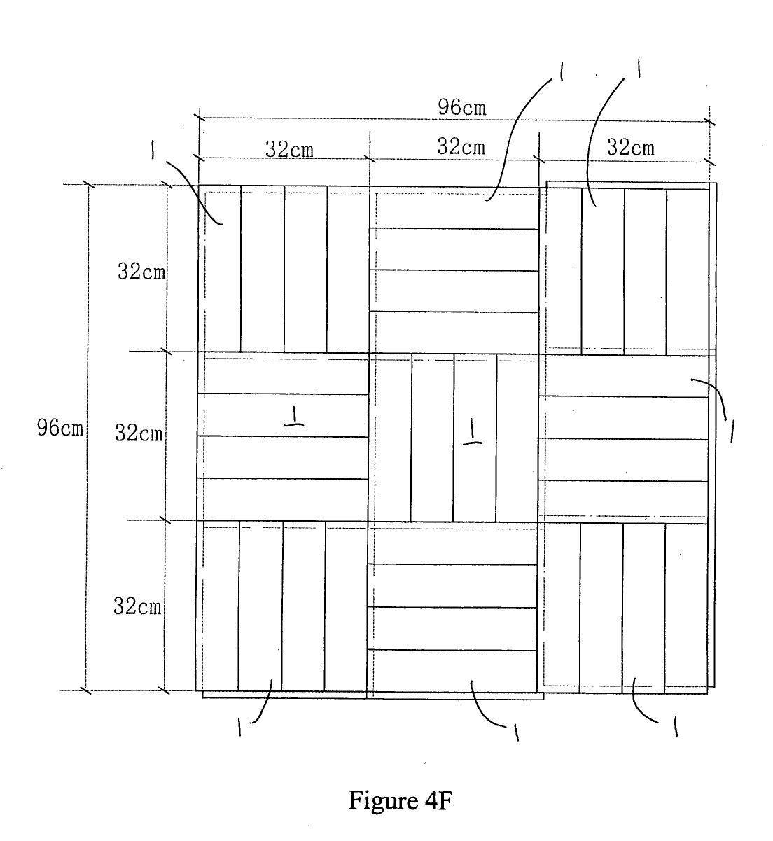

Each of the panels may be of one piece construction, plywood, or other suitable construction. A preferred embodiment of a floor panel system, as in FIG. 1 and FIGS. 4A-4F, constructed in accordance with the present invention comprises:

A floor panel system, comprising:
a plurality of substantially same size and shape wood floor panels 1 matingly and releasably adjoined one to the other,
each floor panel 1 of the plurality of substantially same size and shape wood floor panels 1 adapted to matingly and releasably adjoin to at least two other floor panels 1 of the plurality of substantially same size and shape wood floor panels 1,
   the each floor panel 1 having:
      opposing substantially rectangular cuboid shaped one piece wood board sheets 2 and 4,
         each opposing substantially rectangular cuboid shaped one piece wood board sheets 2 and 4 of the opposing substantially rectangular cuboid shaped one piece wood board sheets 2 and 4 comprising:
         substantially flat opposing first and second surfaces,
         opposing first edges substantially perpendicular to the substantially flat opposing first and second surfaces,
         opposing second edges substantially perpendicular to the substantially flat opposing first and second surfaces and substantially perpendicular to the substantially opposing first edges,
      a substantially centrally disposed substantially rectangular cuboid shaped one piece wood board sheet 3 having substantially the same size and shape as the each opposing substantially rectangular cuboid shaped one piece wood board sheet and having substantially flat opposing third surfaces, opposing third edges, and opposing fourth edges,
         the substantially flat opposing third surfaces bonded to each the substantially flat opposing second surface of the each opposing substantially rectangular cuboid shaped one piece wood board sheet and configured to have one of the opposing third edges and one of the opposing fourth edges extending from the each floor panel 1 forming substantially perpendicular adjacent tongues and substantially perpendicular adjacent grooves.

FIG. 2 shows a top view showing how the offset center board sheet 3 simultaneously forms two adjacent tongue edges as well as two opposite groove edges 5.

FIG. 3 is a top view of square panel 10 with smaller central board sheet 13, top board sheet 11, bottom board sheet 14 and grooves 12 on all four edges. External tongue slats are used with this embodiment.

Each of the panels may be of one piece construction, plywood, or other suitable construction. Each board sheet is preferably a rectangular cuboid, also called a rectangular parallelepiped, of which all faces are rectangular and where “rectangular” implies both rectangles and squares.

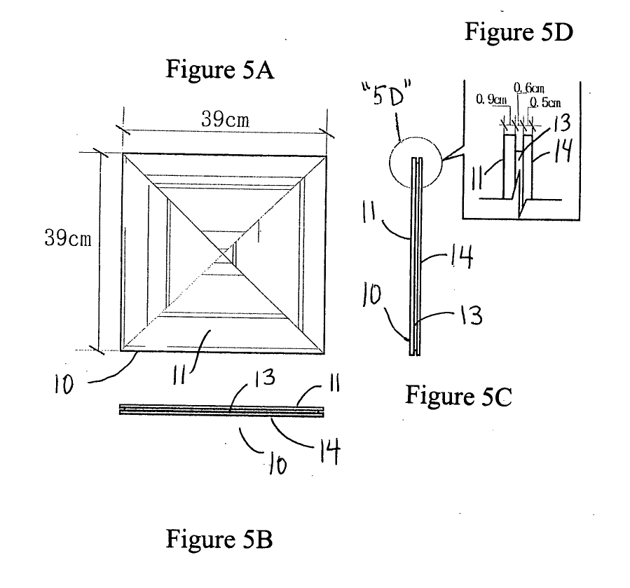

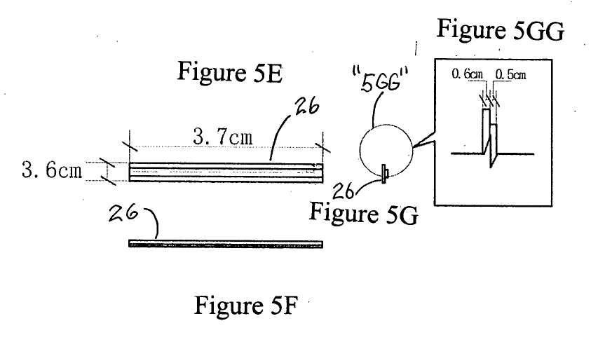

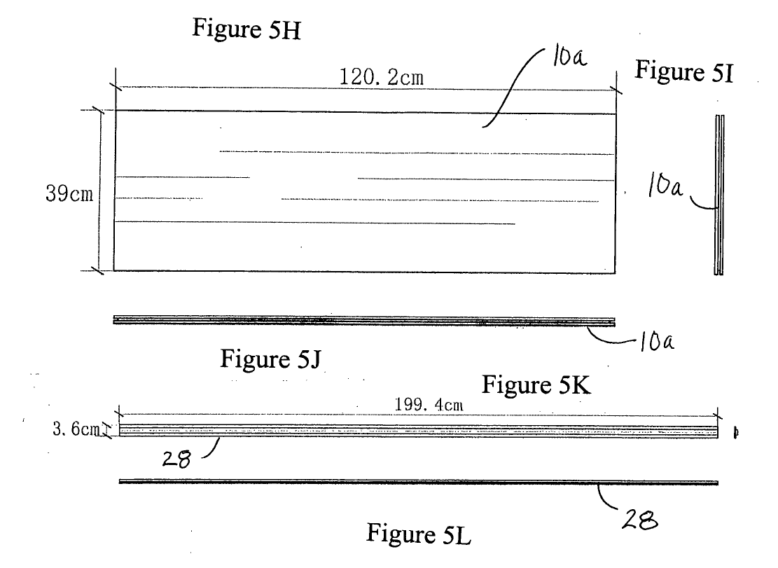

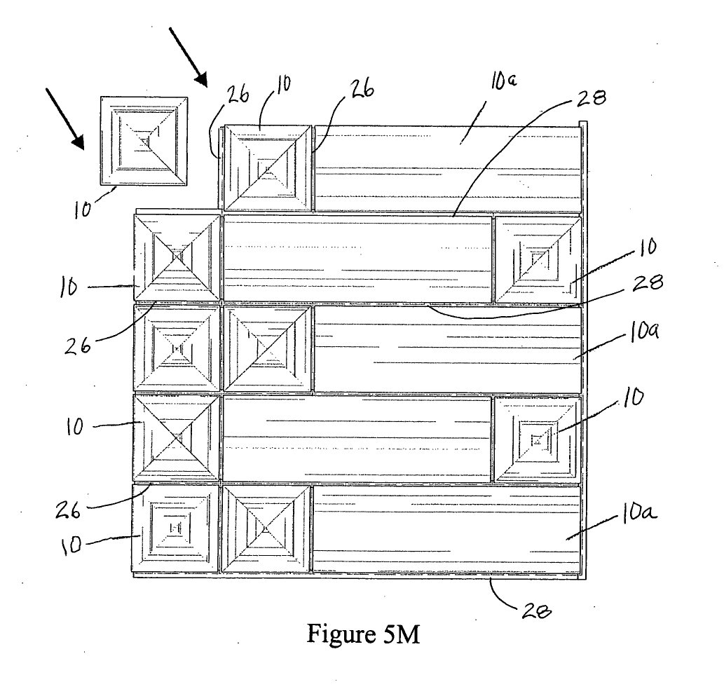

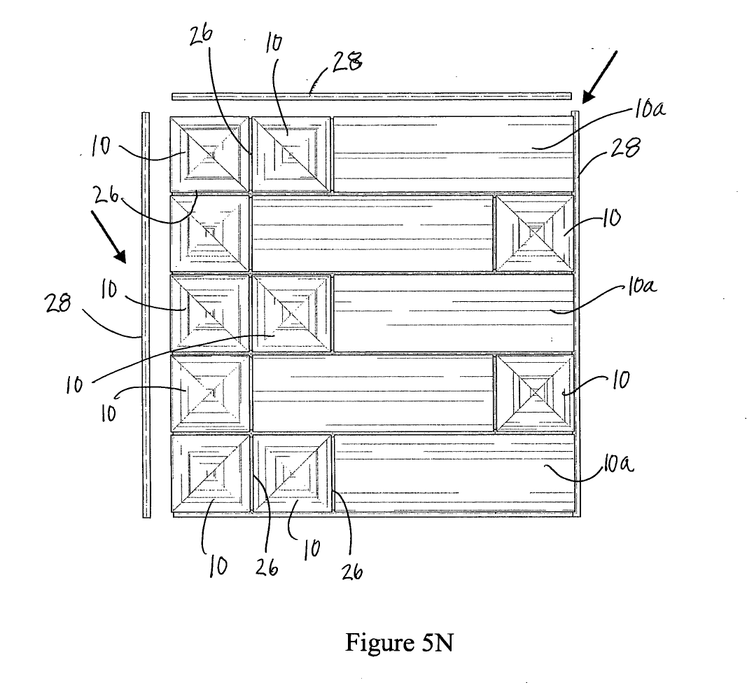

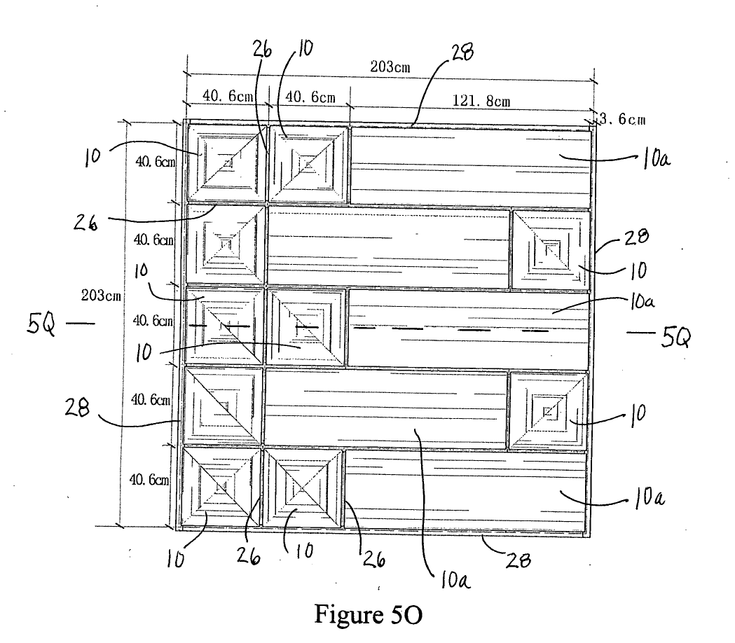

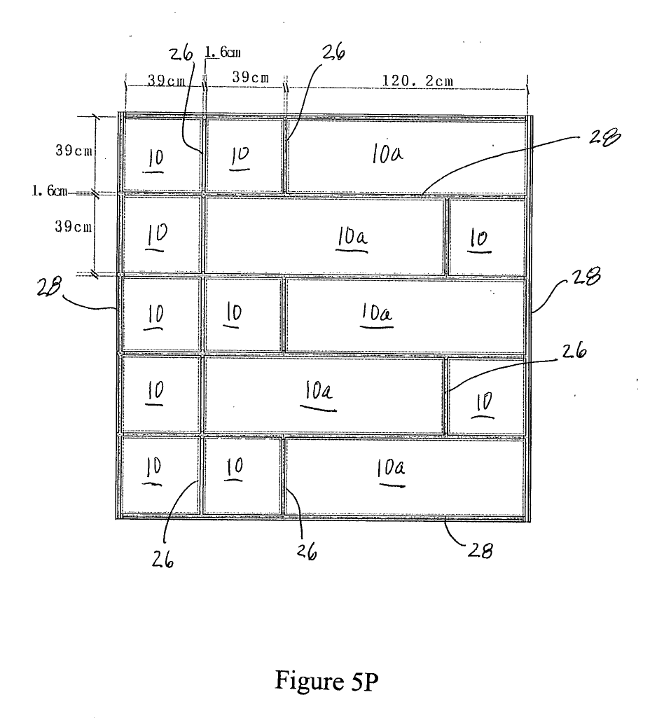

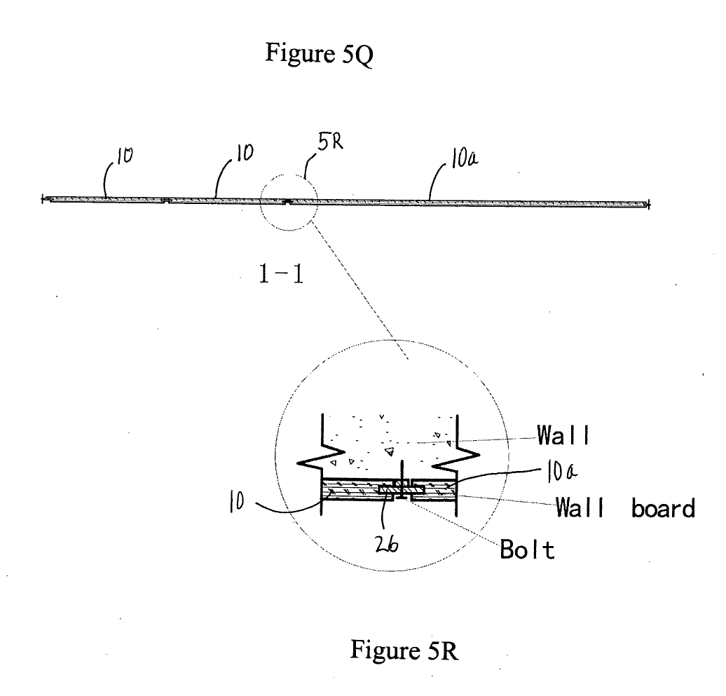

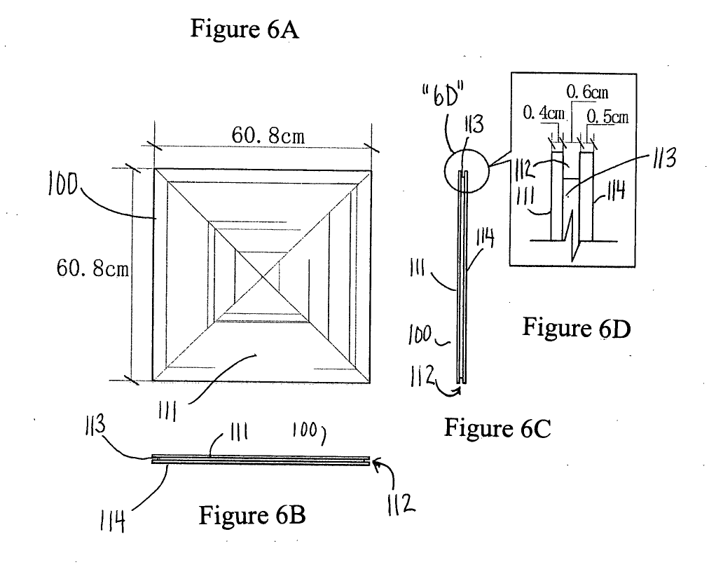

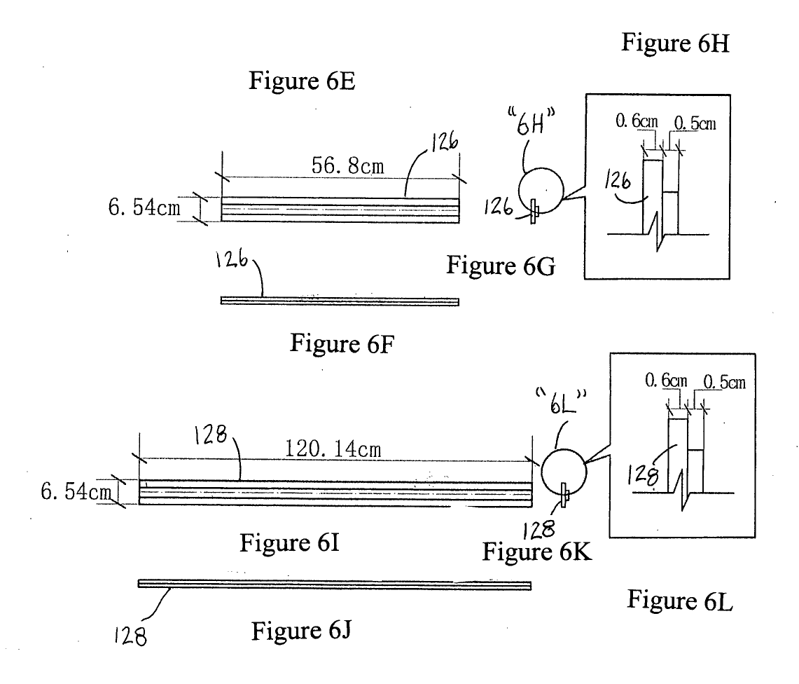

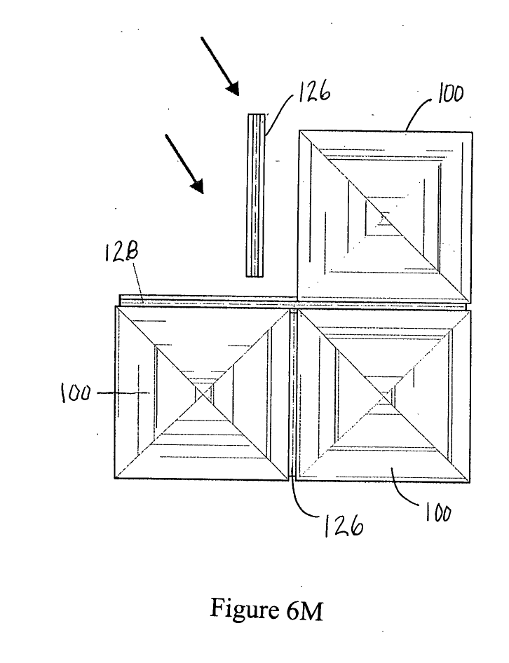

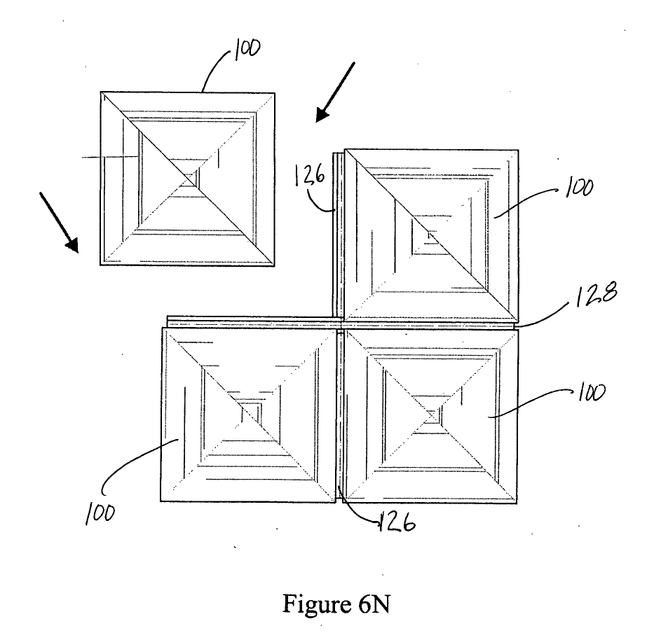

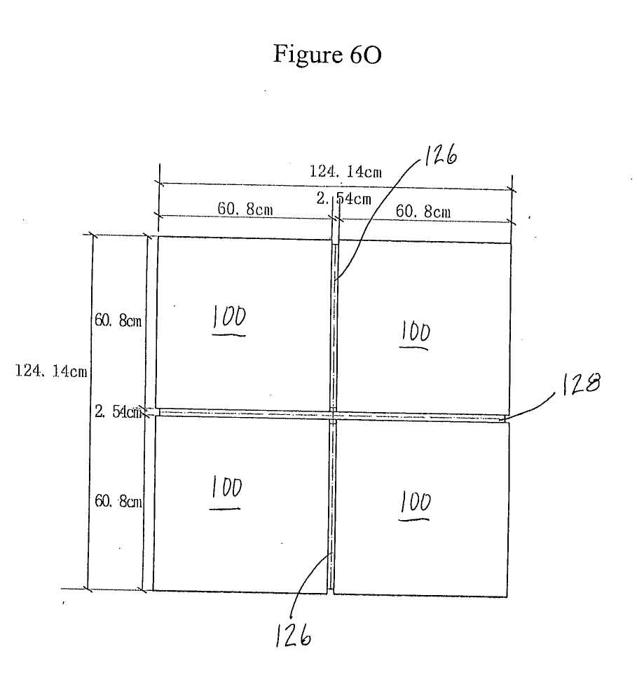

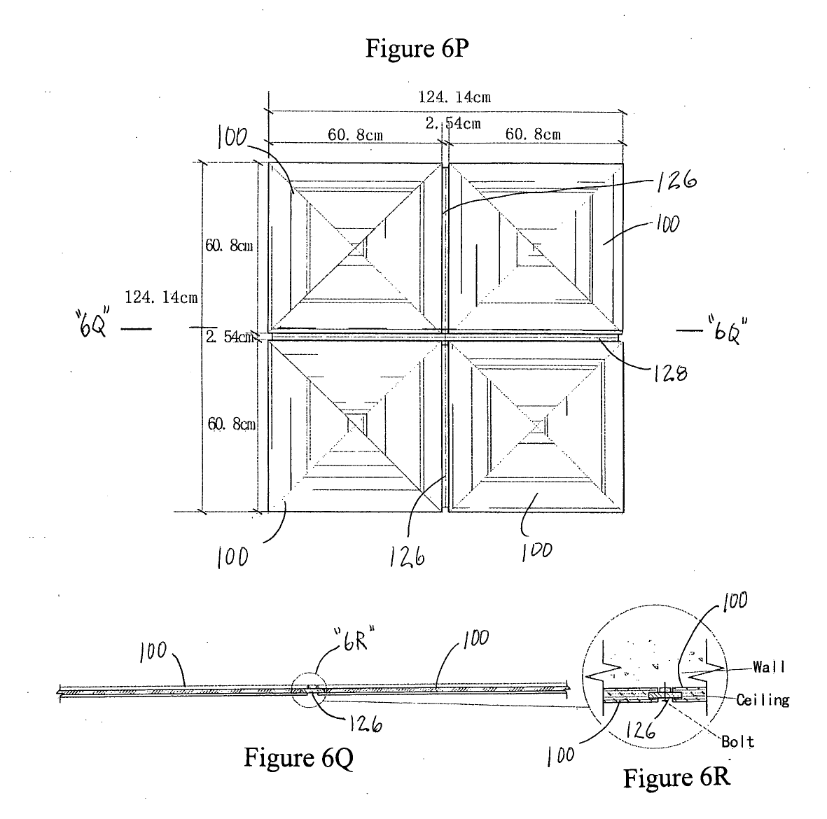

A preferred embodiment of a wall panel system, as in FIGS. 5A-5R constructed in accordance with the present invention, or a ceiling panel system, as in FIGS. 6A-6R, comprises:

a wall or ceiling panel system, comprising:
a plurality of substantially same size and shape wood wall or ceiling panels 10 or 100 panels 100 matingly and releasably adjoined one to the other,
each wall or ceiling panel 10 or 100 of the plurality of substantially same size and shape wood wall or ceiling panels 10 or 100 adapted to matingly and releasably adjoin to at least two other wall or ceiling panels 10 or 100 of the plurality of substantially same size and shape wood wall panels 10 or ceiling panels 100,
   the each wall panel 10 or ceiling panel 100 having:
      opposing substantially rectangular cuboid shaped one piece wood board sheets 11 and 14,
         each opposing substantially rectangular cuboid shaped one piece wood board sheet 11 and 14 of the opposing substantially rectangular cuboid shaped one piece wood board sheets 11 and 14 comprising:
         substantially flat opposing first and second surfaces,
         opposing first edges substantially perpendicular to the substantially flat opposing first and second surfaces,
         opposing second edges substantially perpendicular to the substantially flat opposing first and second surfaces and substantially perpendicular to the substantially opposing first edges,
      a substantially centrally disposed substantially rectangular cuboid shaped one piece wood board sheet 13 smaller than and having substantially the same shape as the each opposing substantially rectangular cuboid shaped one piece wood board sheets 11 and 14 and having substantially flat opposing third surfaces, opposing third edges, and opposing fourth edges,
         the substantially flat opposing third surfaces bonded to each the substantially flat opposing second surface of the each opposing substantially rectangular cuboid shaped one piece wood board sheet and sandwiched therebetween and configured to have the opposing third edges and the opposing fourth edges inwardly disposed within the each wall panel 10 forming opposing first grooves 12 and opposing second grooves 12 substantially perpendicular to the opposing first grooves, each the opposing first groove 12 of the opposing first grooves 12 and each the opposing second groove 12 of the opposing second grooves 12 having substantially the same depth;
      a plurality of spacer block standoffs 27 adapted to be fastened to a wall or ceiling;
      a plurality of first connecting slat tongues fastened to the plurality of standoffs 27,
         each first connecting slat tongue of the plurality of first connecting slat tongues adapted to be matingly and removably received within two adjacent abutting opposing first grooves of the opposing first grooves of two adjacent abutting the plurality of substantially same size and shape wood wall panels 10 or ceiling panels 100;
      a plurality of second connecting slat tongues 28,
         each second connecting slat tongue 28 of the plurality of second connecting slat tongues 28 adapted to be matingly and removably received within two adjacent substantially collinear second grooves 12 of the opposing second grooves 12 of the two adjacent abutting the plurality of substantially same size and shape wood wall panels 10 or ceiling panels 100 and substantially perpendicular to the plurality of first connecting slat tongues 26.

FIGS. 4A-4F show a typical installation of the array of floor board panels 1 with equal sized floor board panels 1 made of top panel board sheet 2, staggered mid panel board sheet 3 leaving two adjacent tongue portions and lower panel board sheet 4, wherein the staggered tongues engage grooves 5 forward between opposite edges of top panel board sheet 2 and lower panel board sheet 4 of an adjacent wall panel 10. While dimensions may vary, preferably square panels 1 have upper board sheets 2 and lower board sheets 4 which are 32 cm in length, sandwiching a mid sheet 3 of 32 cm in length, which extends outward displaying a protruding tongue of 1.3 cm and a corresponding recess on an opposite side of 1.3 cm in depth. Each board sheet is preferably 6 mm, making panel 1 of three board sheets 2, 3 and 4 about 18 mm in thickness. Floor board panels 1 are installed in a plane in the direction of the arrows indicated.

FIGS. 5A-5R show the installation of a typical wall board, where the panels are joined by short slat tongues 26 or long slat tongues 28, which are fastened by fasteners such as nails or screws through slats 26 or 28 and through standoff spacer blocks 27 to an underlying wall surface.

Each top and bottom board sheets 11 and 14 of square panel 10 of FIGS. 3 and 5A, is preferably 39 cm square, sandwiching smaller mid board sheet 13 of 37 cm in length therebetween. Connecting slat tongues 26 are preferably 37 cm in length and 3.6 cm in width and 0.7 cm in thickness, to fit in the grooves 12 on all sides of panel 10, wherein grooves 12 are 0.7 cm in width, to engage corresponding tongues of 0.7 cm in length.

Each top and bottom board sheets of rectangular panels 10a of FIG. 5H are also 39 cm in width, but 120.2 cm in length. Smaller mid board sheets are 3.6 cm in width and 199.4 cm in length, engaging corresponding grooves of 199.4 cm in length formed within rectangular panels 10a.

As shown in FIG. 5O, when assembled in the vertical planar direction of the arrows, two square panels plus corresponding slat tongues each have a length of 40.6 cm×40.6 cm, combined with a long rectangle and corresponding slat tongue totaling 121.8 cm in length, for a combined assembly of 203 cm. Other panels may be added depending upon the wall size to be covered.

In an alternate embodiment, the wall panels can be installed on a ceiling, but preferably each square panel is 2 feet by 2 feet (60.96 cm×60.96 cm).

FIG. 6A is a top view of square ceiling panel 100 with smaller central board sheet 113, top board sheet 111, bottom board sheet 114 and grooves 112 on all four edges. External short connecting slat tongues 126 and long connecting slat tongue 128 of FIG. 6E through 6L are used with this embodiment to connect ceiling panels 100 to each other. Slat tongues 126 or 128 are inserted in place in a plane, in the direction of the arrows shown in FIG. 6M and FIG. 6N. The ceiling panels 100 are connected to a ceiling in a manner similar to that of wall panels in FIG. 5A through FIG. 5R, with fasteners, such as nails or screws, through slat tongues 126 or 128 and bracing standoff spacer blocks 127. While dimensions may vary, ceiling panels 100 are preferably 60.8 cm square (approximately two feet square). Mid panel board sheet 113 is about 56.8 cm square, revealing grooves on all four sides of about 2 cm in depth. Top board sheet 111 is about 0.4 cm in thickness, mid board sheet 113 is about 0.6 cm (as is groove 112 formed thereat) and bottom board sheet is about 0.5 cm in thickness. Short slat tongues 126 are about 5.8 cm×6.54 cm, and long slat tongues 128 are about 120.14 cm in length×6.54 corn in width. FIG. 6Q shows a section of a ceiling covered by a number of square ceiling panels 100. Ceiling board panels 1 are installed in a plane in the horizontal planar direction of the arrows indicated. The ceiling panels 100 can be also installed suspended in a drop ceiling configuration, where there are perpendicular connectors or frames spaced between the panels 100 and the ceiling surface above the panels.

In an alternate embodiment for floor panel 1, as previously shown in FIGS. 1, 2, and 4A-4F, while the three board sheets are substantially equal in thickness, in this alternate embodiment mid board sheets 3 forming tongues may be alternatively slightly thicker at the tongue end than at the end forming the groove between respective top and bottom board sheets 2 and 4, so that they form a tight fit when pushed into the respective grooves formed between top board sheet 2 and bottom board sheet. For example, the protruding end can be 0.63 cm but the groove can be 0.6 cm. Floor board panels 1 are installed in a plane in the direction of the arrows indicated, without any need to divert away from the horizontal planar direction of installation.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

I claim:

1. A surface covering panel for an array of panels for covering one of a floor, a ceiling or a wall comprising:
a plurality of three board sheets of substantially equal thickness, each respective adjacent sheets of said plurality of three board sheets bonded together using adhesive;
an upper board sheet and a lower board sheet being in substantially positional register with each other, and a mid board sheet being offset from said upper and lower board sheets;
whereby offsetting of said mid board sheet forms at least two adjacent reciprocating grooves of said plurality of three board sheets.

2. The surface covering panel as in claim 1 wherein said three board sheets are plywood.

3. The surface covering panel as in claim 1 wherein for a floor panel said two upper and lower of said board sheets which form tongues and grooves are adjacent to each other at respective 90 degrees right angles from each other.

4. The surface covering panel as in claim 1 wherein for ceiling and wall panels said mid board sheet is smaller than said top board sheet and said bottom board sheet, and is centrally located therebetween, thereby providing four equal sized grooves on all four sides of said surface covering panel, whereby each of said four grooves engages a respective slat tongue connecting said panel to an adjacent panel.

5. The surface covering panel as in claim 5 wherein each said connecting slat tongue is connected to a surface via a spacer block provided therebetween.

6. The surface covering panel as in claim 1 wherein said adhesive is mixed with a fire resistant substance.

7. The surface covering panel as in claim 1 wherein said adhesive is mixed with a water resistant substance.

8. The surface covering panel as in claim 1 wherein said adhesive is mixed with an insect resistant substance.

9. A floor panel system, comprising:
a plurality of substantially same size and shape wood floor panels matingly and releasably adjoined one to the other,
each floor panel of said plurality of substantially same size and shape wood floor panels adapted to matingly and releasably adjoin to at least two other floor panels of said plurality of substantially same size and shape wood floor panels,
said each floor panel having:
opposing substantially rectangular cuboid shaped one piece wood board sheets,
each opposing substantially rectangular cuboid shaped one piece wood board sheet of said opposing substantially rectangular cuboid shaped one piece wood board sheets comprising:
substantially flat opposing first and second surfaces,
opposing first edges substantially perpendicular to said substantially flat opposing first and second surfaces,
opposing second edges substantially perpendicular to said substantially flat opposing first and second surfaces and substantially perpendicular to said
substantially opposing first edges,
a substantially centrally disposed substantially rectangular cuboid shaped one piece wood board sheet having substantially the same size and shape as said each opposing substantially rectangular cuboid shaped one piece wood board sheet and having substantially flat opposing third surfaces, opposing third edges, and opposing fourth edges,
said substantially flat opposing third surfaces bonded to each said substantially flat opposing second surface of said each opposing substantially rectangular cuboid shaped one piece wood board sheet and configured to have one of said opposing third edges and one of said opposing fourth edges extending from said each floor panel forming substantially perpendicular adjacent tongues and substantially perpendicular adjacent grooves.

10. A wall panel system, comprising:
a plurality of substantially same size and shape wood wall panels matingly and releasably adjoined one to the other,
each wall panel of said plurality of substantially same size and shape wood wall panels adapted to matingly and releasably adjoin to at least two other wall panels of said plurality of substantially same size and shape wood wall panels,
said each wall panel having:
opposing substantially rectangular cuboid shaped one piece wood board sheets,
each opposing substantially rectangular cuboid shaped one piece wood board sheet of said opposing substantially rectangular cuboid shaped one piece wood board sheets comprising:
substantially flat opposing first and second surfaces,
opposing first edges substantially perpendicular to said substantially flat opposing first and second surfaces,
opposing second edges substantially perpendicular to said substantially flat opposing first and second surfaces and substantially perpendicular to said substantially opposing first edges,
a substantially centrally disposed substantially rectangular cuboid shaped one piece wood board sheet smaller than and having substantially the same shape as said each opposing substantially rectangular cuboid shaped one piece wood board and having substantially flat opposing third surfaces, opposing third edges, and opposing fourth edges,
said substantially flat opposing third surfaces bonded to each said substantially flat opposing second surface of said each opposing substantially rectangular cuboid shaped one piece wood board sheet and sandwiched therebetween and configured to have said opposing third edges and said opposing fourth edges inwardly disposed within said each wall panel forming opposing first grooves and opposing second grooves substantially perpendicular to said opposing first grooves, each said opposing first groove of said opposing first grooves and each said opposing second groove of said opposing second grooves having substantially the same depth;
a plurality of standoffs adapted to be fastened to a wall;
a plurality of first tongues fastened to said plurality of standoffs,
each first tongue of said plurality of first tongues adapted to be matingly and removably received within two adjacent abutting opposing first grooves of said opposing first grooves of two adjacent abutting said plurality of substantially same size and shape wood wall panels;
a plurality of second tongues,
each second tongue of said plurality of second tongues adapted to be matingly and removably received within two adjacent substantially collinear second grooves of said opposing second grooves of said two adjacent abutting said plurality of substantially same size and shape wood wall panels and substantially perpendicular to said plurality of first tongues.

11. A ceiling panel system, comprising:
a plurality of substantially same size and shape wood ceiling panels matingly and releasably adjoined one to the other,
each ceiling panel of said plurality of substantially same size and shape wood ceiling panels adapted to matingly and releasably adjoin to at least two other ceiling panels of said plurality of substantially same size and shape wood ceiling panels,
said each ceiling panel having:
opposing substantially rectangular cuboid shaped one piece wood board sheets,
each opposing substantially rectangular cuboid shaped one piece wood board sheet of said opposing substantially rectangular cuboid shaped one piece wood board sheets comprising:
substantially flat opposing first and second surfaces,
opposing first edges substantially perpendicular to said substantially flat opposing first and second surfaces,
opposing second edges substantially perpendicular to said substantially flat opposing first and second surfaces and substantially perpendicular to said substantially opposing first edges,
a substantially centrally disposed substantially rectangular cuboid shaped one piece wood board sheet smaller than and having substantially the same shape as said each opposing substantially rectangular cuboid shaped one piece wood board and having substantially flat opposing third surfaces, opposing third edges, and opposing fourth edges,
said substantially flat opposing third surfaces bonded to each said substantially flat opposing second surface of said each opposing substantially rectangular cuboid shaped one piece wood board sheet and sandwiched therebetween and configured to have said opposing third edges and said opposing fourth edges inwardly disposed within said each ceiling panel forming opposing first grooves and opposing second grooves substantially perpendicular to said opposing first grooves, each said opposing first groove of said opposing first grooves and each said opposing second groove of said opposing second grooves having substantially the same depth;
a plurality of standoffs adapted to be fastened to a ceiling;
a plurality of first tongues fastened to said plurality of standoffs,
each first tongue of said plurality of first tongues adapted to be matingly and removably received within two adjacent abutting opposing first grooves of said opposing first grooves of two adjacent abutting said plurality of substantially same size and shape wood ceiling panels;
a plurality of second tongues,
each second tongue of said plurality of second tongues adapted to be matingly and removably received within two adjacent substantially collinear second grooves of said opposing second grooves of said two adjacent abutting said plurality of substantially same size and shape wood ceiling panels and substantially perpendicular to said plurality of first tongues.

12. The floor panel system as in claim 9, wherein said opposing first edges and said opposing second edges are of substantially the same length.

13. The floor panel system as in claim 9, wherein said opposing first edges each have a first length and said opposing second edges each have a second length different from said first length.

14. The wall panel system as in claim 10, wherein-said opposing first edges and said opposing second edges are of substantially the same length.

15. The wall panel system as in claim 10, wherein said opposing first edges each have a first length and said opposing second edges each have a second length different from said first length.

16. The ceiling panel system as in claim 11, wherein-said opposing first edges and said opposing second edges are of substantially the same length.

17. The ceiling panel system as in claim 11, wherein said opposing first edges each have a first length and said opposing second edges each have a second length different from said first length.

18. The floor panel system as in claim 12, wherein said each floor panel has a thickness substantially less than said substantially same length of said opposing first edges and said opposing second edges.

19. The floor panel system as in claim 13, wherein said each floor panel has a thickness substantially less than said first length and substantially less than said second length.

20. The wall panel system as in claim 14, wherein said each floor panel has a thickness substantially less than said substantially same length of said opposing first edges and said opposing second edges.

21. The wall panel system as in claim 15, wherein said each floor panel has a thickness substantially less than said first length and substantially less than, said second length.

22. The ceiling panel system as in claim 16, wherein said each floor panel has a thickness substantially less than said substantially same length of said opposing first edges and said opposing second edges.

23. The ceiling panel system as in claim 17, wherein said each floor panel has a thickness substantially less than said first length and substantially less than said second length.
